(19) United States
(12) Patent Application Publication
(10) Pub. No.: US 2009/0066859 A1
(43) Pub. Date: Mar. 12, 2009

(54) MOOD GENERATING DEVICE

(76) Inventor: William Huckestein, Westlake Village, CA (US)

Correspondence Address: T. D. FOSTER, 12760 HIGH BLUFF DRIVE, SUITE 300, SAN DIEGO, CA, 92130, US

(21) Appl. No.: 12/047,659

(22) Filed: Mar. 13, 2008

Related U.S. Application Data
(60) Provisional application No. 60/906,707, filed on Mar. 13, 2007.

(51) Int. Cl. H04N 3/14

(52) U.S. Cl. 348/790; 348/E03.016

(57) ABSTRACT

The present invention relates to electronic mood generating devices. The present invention is particularly adaptable for providing rapidly induced moods, states-of-mind, emotional conditions or overall physiological and behavioral orientations toward relaxation, creativity, inspiration, motivation, or meditation by embedding a series of themed acoustics and images on a standalone device. The present invention can be easily used by anyone due to the simplicity of accessing the pre-programmed themed content, namely through the touch of a button, and the simplicity of reprogramming the buttons to access user-provided content.

### RELATED DOCUMENTS

This application claims benefit of priority to U.S. Provisional Application Ser. No. 60/906,707, filed Mar. 13, 2007, entitled “Mood Generating Device” which is incorporated by reference herein in its entirety.

### FIELD OF INVENTION

The present invention relates generally to the field of mood generating devices, and particularly devices that rapidly induce a mood, state-of-mind, emotional condition or overall physiological and behavioral orientation toward relaxation, creativity, inspiration, motivation, or meditation by embedding a series of themed acoustics and images on a standalone device.

### BACKGROUND OF THE INVENTION

The Mood Generating Device of the present invention is a new product that improves the 1) traditional printed inspirational displays, 2) digital picture frames, and 3) acoustic-only devices currently in the market.

In the case of traditional printed displays, these products are typically printed photographs that are either framed for wall-mounting or desk and table-top displays. As such, they are physically limited to the single photograph or painting in the frame. In order to substitute in a photograph of a different mood, or another variety of the same mood, a consumer would have to disassemble the framed photograph and replace the photograph, or remove the framed photograph and replace it with another framed photograph. The Mood Generating Device of the present invention addresses these limitations.

In the case of digital picture frames, they are typically designed to display digital images stored on Flash media cards. Some digital pictures are manufactured with embedded Flash memory, allowing consumers to transfer digital pictures and music files via wired and wireless connections between the device and a consumer's computer. Some digital picture frames also play music files if such music files are loaded onto the Flash media card or transferred onto the device's on-board memory. However, the current digital pictures, even the most advanced of them, provide no way for consumers to organize groups or themes of digital pictures and audio files that can be activated with push button ease. Although it is possible for a manufacturer to embed a selection of images and one audio track on a digital picture frame, the current technology provides no way for these images to be grouped, and for each group to have a corresponding audio file, and for each group to be accessed via buttons on the device itself or via the device's remote control unit. Based on current technological limitations, a consumer would have to acquire a sufficiency of Flash media cards, place a series of images and one corresponding audio file conducive to a given mood on each Flash media card, and then manually switch between the Flash media cards in order to change the active mood or theme on the digital picture frame. The Mood Generating Device of the present invention overcomes these limitations as well.

In the case of acoustic only devices, there are many such devices designed to play sounds that induce one or more moods. For example, there are many acoustic-only devices that play sounds of nature to induce the state of relaxation. However, these devices are not capable of displaying digital imagery that accentuates and supports the audio being played. The present invention overcomes this limitation as well.

### SUMMARY OF THE INVENTION

The Mood Generating Device of the present invention is a new product that improves the 1) traditional printed inspirational displays, 2) digital picture frames, and 3) acoustic-only devices currently in the market by embedding a series of themed acoustics and images on a standalone device.

One aspect of the present invention includes a mood generating device comprising: a) a digital picture frame operatively connected to an electronic screen, controlled by firmware that loads an operating system comprising on-screen menus, with one or more on-screen menus that display one or more programmable virtual buttons that display one or a group of images related to the particular mood simultaneously with the playing of the audio file related to the particular mood; b) one or more speakers able to generate acoustic musical sounds from digital audio files from the digital memory source, the speakers being operatively connected to the digital picture frame such that when one, a series, or a group of the multiple images are being displayed relating to a particular mood, one of the audio files plays music related to the particular mood through the speakers; and c) one or more push-buttons operatively connected to the digital picture frame and/or to a remote control device, such that a user can press one of the push-buttons and activate the displaying of the one, a series, or a group of images related to the particular mood simultaneously with the playing of the audio file related to the particular mood.

### BRIEF DESCRIPTION OF THE DRAWINGS

FIG. 1 shows a front view of the buttons used to reprogram content featuring icons.

FIG. 2 shows a front view of the buttons used to reprogram content featuring descriptions.

FIG. 3 shows a perspective view of the device with a black frame featuring iconic content buttons, and also including a custom designed and engineered remote control unit bearing the same buttons.

FIG. 4 shows a perspective view of the device with a black frame featuring description content buttons and also including a custom designed and engineered remote control unit bearing the same buttons.

FIG. 5 shows a perspective view of the device with a white frame featuring iconic content buttons and also including a custom designed and engineered remote control unit bearing the same buttons.

FIG. 6 shows a perspective view of the device with a white frame featuring description content buttons and also including a custom designed and engineered remote control unit bearing the same buttons.

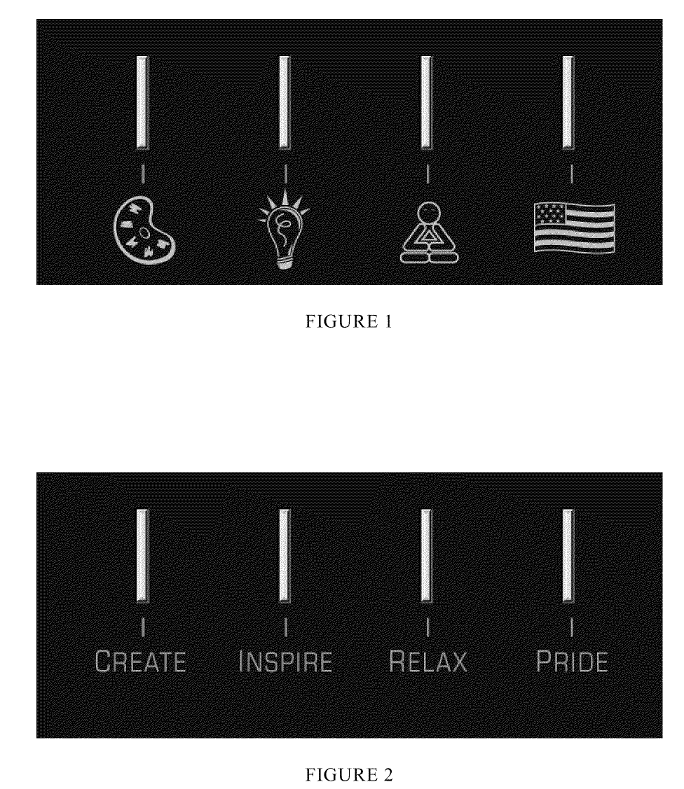

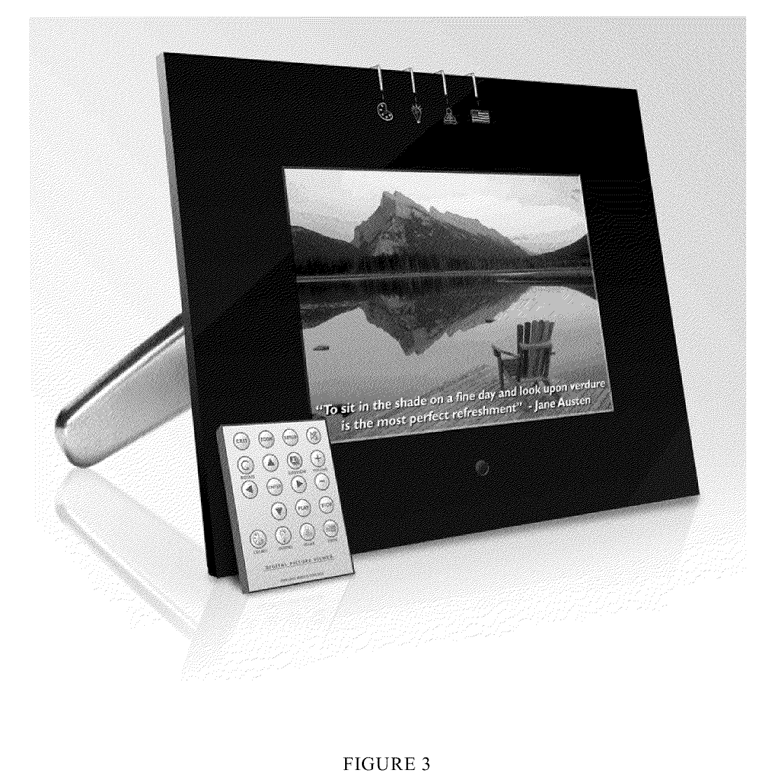

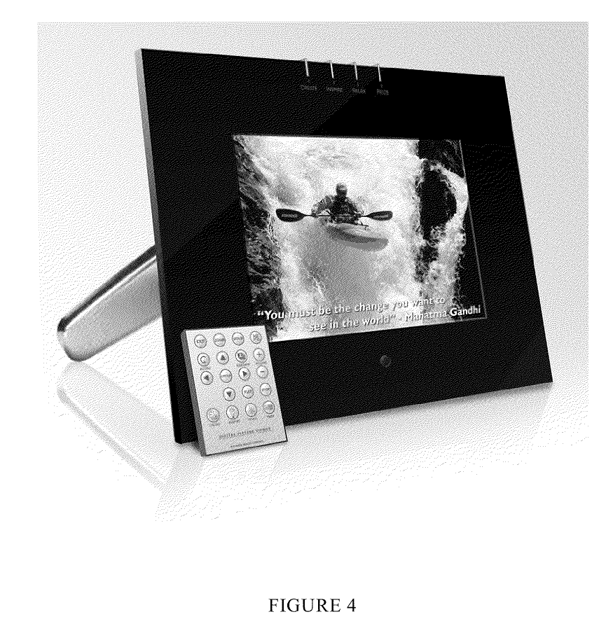

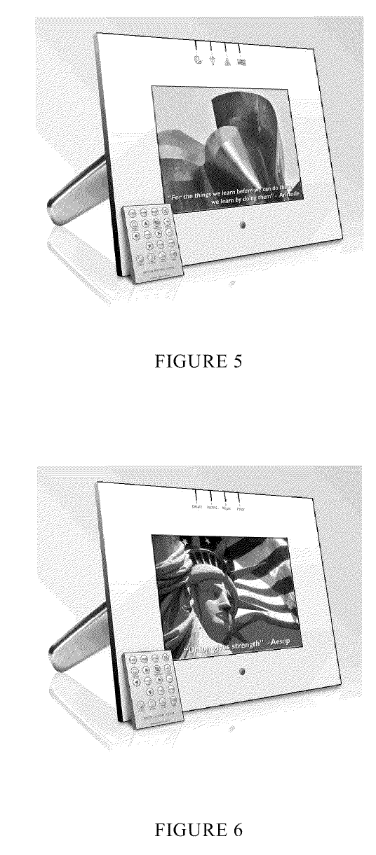

### DETAILED DESCRIPTION OF THE INVENTION

The Mood Generating Device of the present invention is a new product that improves the 1) traditional printed inspirational displays, 2) digital picture frames and 3) acoustic-only devices currently in the market.

In the case of traditional printed displays, these products are typically printed photographs that are either framed for wall-mounting, desk or table-top displays. The Mood Generating Device of the present invention overcomes the physical limitations of traditionally framed inspirational photography through the use of a digital picture frame that is pre-programmed with multiple images relating to different moods or themes, allowing the user to instantly choose from among a range of moods or themes, and to either select a single image or a slideshow of multiple images within a given mood category.

In the case of digital picture frames, they are typically designed to display digital images stored on Flash media cards. The Mood Generating Device of the present invention overcomes this limitation through a digital picture frame design that includes a series of buttons where each button, through proper circuitry, engineering, and firmware encoding, is linked to a folder within the device's on-board memory. In other words, Applicant's technology includes firmware code and system display functionality that allow for consumers to optionally change and reprogram the content activated by each button.

In the case of acoustic only devices, these devices are not capable of displaying digital imagery that accentuates and supports the audio being played. The present invention overcomes this limitation by incorporating a color screen of varying sizes and resolutions onto a device with the acoustics capability. Moreover, the present invention can incorporate custom engineering and hardware programming to match specific images with specific acoustics into groups or categories of content, and to allow these groups to be selected with the push of a button.

The end result is that the device achieves the desired mood altering effect by embedding a series of themed acoustics and images on a standalone device, and presenting them via an electronic screen (whether analog LCD, digital LCD, LED, OLED, AMOLED, ALED or other screen technology) and stereo speakers, and allowing for user operation through a series of push-buttons on both the device itself and the device's remote control unit. In its primary embodiment, the Mood Generating Device is a standalone device that requires no external feed for its content, such as via a network, (wired or wireless), cable, satellite or terrestrial broadcast. In another embodiment, the Mood Generating Device is equipped with networking capability, such as WIFI, wired Ethernet, broadband cell connectivity (Verizon®'s EVDO and Sprint®/Cingular®'s UMTS/HSPDA, and a hosted server application that allows the user to assign the device's (on-board and remote) buttons to an unlimited number of moods or themes existing on the hosted servers or on 3^{rd} party websites, and to even define an unlimited number of moods or themes on the hosted server. For example, the user can access the hosted server application online and log on to a private account associated with the user's Mood Generating Device and define a channel called “Stars of the Sky” by using keywords and search terms relating to astronomy. The server-side application will then search for images related to the entered search terms on public Photo Websites such as Flickr, or any other websites designated by the user. The user can also provide the hosted server application with the user's online credentials to 3^{rd} party websites and assign the device's buttons to the user's existing albums of imagery on those websites. The user can also search for music files and associate a given music file with the images defined for a mood or theme. In this secondary embodiment, the user can choose to have the server download a specific number of images and one audio file per a given theme or mood button, where the number of images is limited by the storage capacity of the Mood Generating Device's onboard memory or the memory capacity of the Flash media card inserted into the Mood Generating Device, or the user can choose to have the server stream an indefinite number of images instead of downloading them. In the case of a stream of a broad channel such as “Stars of the Sky” the number of images could be in the tens of thousands if not more.

The design and technology of the present invention provide for alternative embodiments due to the firmware code and system display functionality that allow for an endless variety of commercial and retail applications to accommodate different market interests. The invention can be reprogrammed, for example, to create a “Sight and Sound World” product that fosters international appreciation and tourism, where buttons on the device and the device's remote control can be programmed to present scenes and sounds of, for example, the America's, China, Europe, Africa, Polynesia, Greece, and the like. Alternatively, the present invention can be used to create a “Hall of Fame Memorabilia” product, where each of the device's buttons would link to a series of pictures and audio files about a given Hall of Famer inductee. For example, one application of the invention could be a 2007 Hall of Famer product, with button 1 for Tony Gwynn, Button 2 for Cal Ripkin, Button 3 for Gene Hickerson, Button 4 for Michael Irvin, button 5 for Bruce Mathews, Button 6 for Charlie Sanders, Button 7 for Thurman Thomas, and Button 8 for Roger Wehrli, with additional buttons for the 2007 Basketball Hall of Famers. The applications of the present invention are innumerable.

Additionally, the present invention includes firmware code and system functionality that allow for the customers themselves to optionally change and reprogram the content activated by each button, so they are not limited by the manufacturer's preprogrammed audio and image content. A consumer, for example, may wish to reprogram each of the buttons to display personal and family achievements, such as the wedding, first child, first family vacation, family reunion, and the like. The consumer does not have any content restrictions, so is not limited in how the device could be customized and reprogrammed. For example, the consumer themselves would reprogram their device into their own Hall of Famer Memorabilia device, providing they had access to such pictures in their personal possession.

The buttons featured on the present invention used to reprogram the content are not limited in their positioning or their quantity. The buttons are used to load pre-programmed images linked to a pre-programmed audio file. The buttons can also reprogrammed by the user to load user-generated or user-supplied photos and an audio file. Although the primary embodiments illustrates 4 buttons, the device may feature many more. The number of buttons on the device is only limited by the physical space on the frame of the device. Moreover, the device may feature innumerable virtual buttons that can be selected and managed via the device's on-screen operating system. The on-screen operating system can in turn be accessed via the system control, for example, on the back of the device, via the remote control, and/or via other technologies such as touch screen. Although the primary embodiment shows the buttons located on top and front of the frame, the buttons can alternatively be placed on the bottom, left and/or right side of the frame. The buttons could also be removed from the device itself, and placed on the remote control unit alone. Moreover, the frame itself can be of a custom shape, a different color (white, grey, black, red, green, etc.), and the material of the frame can be of a different type (wood, acrylic, leather, etc.). The invention also includes a custom designed and engineered remote control unit that provides the same push-button access to the moods on the device.

### I. A Mood Generating Device

The Mood Generating Device of the present invention is a new product that includes a digital picture frame operatively connected to an electronic screen, controlled by firmware that loads an operating system comprising on-screen menus, with one or more on-screen menus that display one or more programmable virtual buttons that display one or a group of images related to the particular mood simultaneously with the playing of the audio file related to the particular mood.

The present invention also includes one or more speakers able to generate acoustic musical sounds from digital audio files from the digital memory source, the speakers being operatively connected to the digital picture frame such that when one, a series, or a group of the multiple images are being displayed relating to a particular mood, one of the audio files plays music related to the particular mood through the speakers.

The present invention also includes one or more push-buttons operatively connected to the digital picture frame such that a user can press one of the push-buttons and activate the displaying of the one, a series, or a group of images related to the particular mood simultaneously with the playing of the audio file related to the particular mood.

The present invention may further include a remote control unit for controlling the operation of the mood generating device.

The present invention may be configured to include a digital memory source that is internal to the digital picture frame, external to the digital picture frame, or a combination of both.

The present invention may further include a plurality of digital memory media accepting slots for accepting various types of digital memory media, such as a flash media accepting slot and a flash memory card accepting slot.

The present invention may be configured to have an electronic screen such as an analog liquid crystal display, digital liquid crystal display, light emitting diode, organic light emitting diode, active matrix organic light emitting diode, or amplified light emitting diode.

### EXAMPLES

### Example 1

### A Mood Generating Device

A Digital Photo Frame features an electronic screen (analog or digital), typically a TFT screen made by LG®/Philips®, Samsung®, AU®, CMO, Sharp®, Hitachi®, and other panel manufacturers. The screen is connected to a controller on a circuit board and housed in mold that typically resembles a traditional photo frame. The circuit board is typically powered by a SystemOnChip (SoC) processor designed to decode and display images typically of the jpeg variety and audio files typically of the mp3 format. The processor may also support the decoding of video files of popular formats, such as MPEG4. The popular SoC processors in the market include Zoran, Cheertek, MagicPixel, Haier, Sunplus, Amlogic, Sigmatel and others. In addition to the SoC processors, the digital photo frames may be powered by ARM processors from Marvell and other licensees of the ARM core. In the case of the SoC processors, the graphical processing may be handled by a secondary specialized chip. The circuit board often features DDR, SDRAM or NOR Flash memory to store operating system functions, a ROM also known as firmware, and NAND Flash memory to store user supplied content within internal (also known as onboard) memory. Connected to the circuit board may be a memory card reader and USB Flash drive connector. The memory card reader typically supports SD memory cards, and can also support Compact Flash (CF), Memory Stick and Memory Stick Pro, Multimedia Card (MMC), xD, SM (Smart Media). If there is internal (onboard) memory, the USB Flash drive connector typically supports USB Host and Guest configurations, allowing the device to connect to a computer and an external USB Flash drive. The circuit board may also feature a wifi and/or Bluetooth chip, such as the wifi and Bluetooth chips made by Atheros, Azurewave and Marvell. The circuit board may also feature an EDGE or 3G chip, such as those made by Wavecon and Infineon, and an Ethernet port, for additional connectivity options. There are no mechanical moving parts as in a cooling system or hard disk as a computer would have. There are no input options (such as a keyboard or mouse) other than the on-screen controls and the remote control device or push buttons. Also connected to the circuit board are speakers, typically 2 speakers each of approximately 1 Watt in output, and a connector for the power adaptor. The circuit board, speakers, media card reader, USB Flash drive connector and electronic screen are typically contained in plastic ABS housing. An acrylic or wooden frame can be attached to the front of the housing to establish the decorative facade. The back of the housing may include a stand that rotates so that the device can interchangeably sit on its longer or shorter side for portrait or landscape orientation. The back or side of the housing can also feature an On/Off button. In addition, the back of the housing often includes four notches to allow for wall mounting in either landscape or portrait orientation.

What is claimed is:

1. A mood generating device comprising:
a) a digital picture frame operatively connected to an electronic screen, controlled by firmware that loads an operating system comprising on-screen menus, with one or more on-screen menus that display one or more programmable virtual buttons that display one or a group of images related to the particular mood simultaneously with the playing of the audio file related to the particular mood;
b) one or more speakers able to generate acoustic musical sounds from digital audio files from the digital memory source, the speakers being operatively connected to the digital picture frame such that when one, a series, or a group of the multiple images are being displayed relating to a particular mood, one of the audio files plays music related to the particular mood through the speakers; and
c) one or more push-buttons operatively connected to the digital picture frame such that a user can press one of the push-buttons and activate the displaying of the one, a series, or a group of images related to the particular mood simultaneously with the playing of the audio file related to the particular mood.

2. The device of claim 1, wherein the content displayed and accessible via its push buttons includes videos, animations, text, RSS, and other forms of content.

3. The device of claim 1, further comprising a remote control unit for controlling the operation of the mood generating device.

4. The device of claim 1, wherein said digital memory source is internal to the digital picture frame, external to said digital picture frame, or a combination of both.

5. The device of claim 1, further comprising a plurality of digital memory media accepting slots for accepting various types of digital memory media.

6. The device of claim 5, wherein the digital memory media accepting slots comprises one or more flash media card accepting slots.

7. The device of claim 1, wherein the electronic screen is selected from the group consisting of analog liquid crystal display, digital liquid crystal display, light emitting diode, organic light emitting diode, active matrix organic light emitting diode, and amplified light emitting diode.

8. The device of claim 1, wherein said one or more speakers are stereo speakers.

9. The device of claim 1, wherein the digital picture frame is of a custom shape, color, or material.

10. The device of claim 1, wherein the one or more push-buttons are used to reprogram content related to a particular mood being selected.

11. The device of claim 1, wherein the push-buttons are located on the top, on the bottom, or on either side of the digital picture frame, or a combination thereof.

12. The device of claim 1, wherein the electronic screen is a touch-screen able to control the functionality of the operating system from touch commands on the electronic screen.

13. The device of claim 1, wherein the digital memory source resides on one or more servers accessible via the world wide web, and where the content is transmitted to the device via a WIFI, WiMAX, wired Ethernet, 3G, cell broadband or basic telephone connection from the device to the internet and vice versa.
